(19) United States
(12) Patent Application Publication
(10) Pub. No.: US 2016/0101567 A1
(43) Pub. Date: Apr. 14, 2016

(54) METHODS OF EXTRUDING A MULTI-COLORED MOLTEN FILAMENT MATERIAL AND NOZZLE FOR USE THEREWITH

(71) Applicant: HON HAI PRECISION INDUSTRY CO., LTD., New Taipei (TW)

(72) Inventors: EDWARD JOHN VAN LIEW, Santa Clara, CA (US); ERNEST DALE JENKINS, Santa Clara, CA (US); JOSEPH ALAN WOLFMAN, Santa Clara, CA (US)

(21) Appl. No.: 14/509,648

(22) Filed: Oct. 8, 2014

(51) Int. Cl. B29C 67/00

(52) U.S. Cl. CPC B29C 67/0085; B29C 67/0055; B29K 2067/046

(57) ABSTRACT

A method of forming a three-dimensional multi-colored object is described. According to the method, molten base filament is used for forming the shape of the object. Before the molten base filament is deposited, colorant is added to the molten base filament to form a colored molten base filament, generally in the shape of a small colored slug. Finally, the colored molten base filament is formed into the size, shape and color of the three-dimensional multi-colored colored object. A nozzle for use with the method is also described.

### FIELD

The present disclosure relates to methods of 3D printing.

### BACKGROUND

Existing consumer based “3D printing” machines allow only one color per object. The filament is one color (for example, red) and entire object is produced in that color. The filament is typically extruded to form a 3D object.

### BRIEF DESCRIPTION OF THE DRAWINGS

Implementations of the present technology will now be described, by way of example only, with reference to the attached drawings.

FIG. 1 is a flowchart of a first exemplary method of extruding a multi-colored molten filament.

FIG. 2 is a flow chart further depicting the adding colorant step of FIG. 1.

FIG. 3 is a flowchart of a second exemplary method of extruding a multi-colored molten filament.

FIG. 4 is a diagrammatic illustration of a nozzle according to an exemplary embodiment.

FIG. 5 is a diagrammatic illustration showing the exemplary nozzle of FIG. 4 having the capability of mixing multiple colorants together.

FIG. 6 is a diagrammatic illustration showing the exemplary nozzle feeding molten base filament.

FIG. 7 is a diagrammatic illustration showing the exemplary nozzle feeding molten base filament while mixing multiple colorants together in preparation of feeding a molten base filament material having a first color.

FIG. 8 is a diagrammatic illustration showing the exemplary nozzle prior to feeding the base material having the first color while mixing multiple different colorants together in preparation of feeding a molten base filament having a second color.

FIG. 9 is a diagrammatic illustration showing the exemplary nozzle beginning to extrude the molten base filament having the first color, while the second color remains in the nozzle and while mixing multiple different colorants together in preparation of feeding a molten base filament having a third color.

FIG. 10 is a diagrammatic illustration showing the exemplary nozzle having completely extruded the molten base filament having the first and second color and beginning to extrude the molten base filament having the third color.

FIG. 11 is a diagrammatic illustration showing the exemplary nozzle after having extruded the molten base filament material of the first, second, and third colors.

### DETAILED DESCRIPTION

It will be appreciated that for simplicity and clarity of illustration, where appropriate, reference numerals have been repeated among the different FIGS. to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

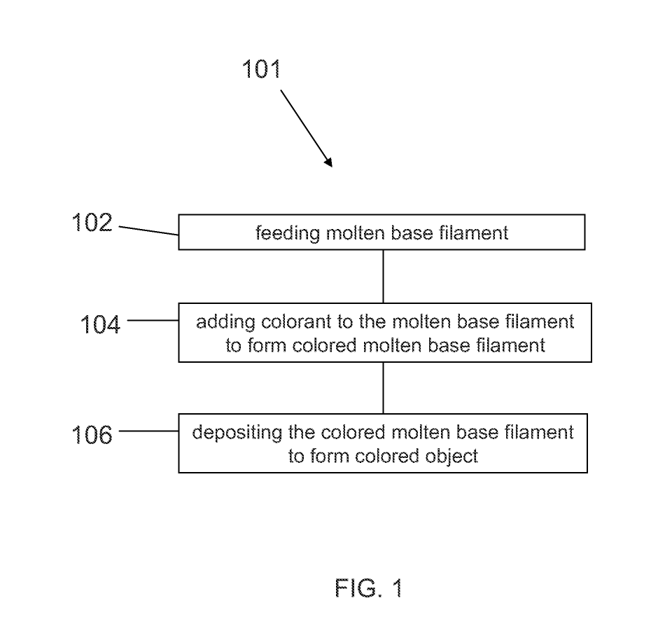

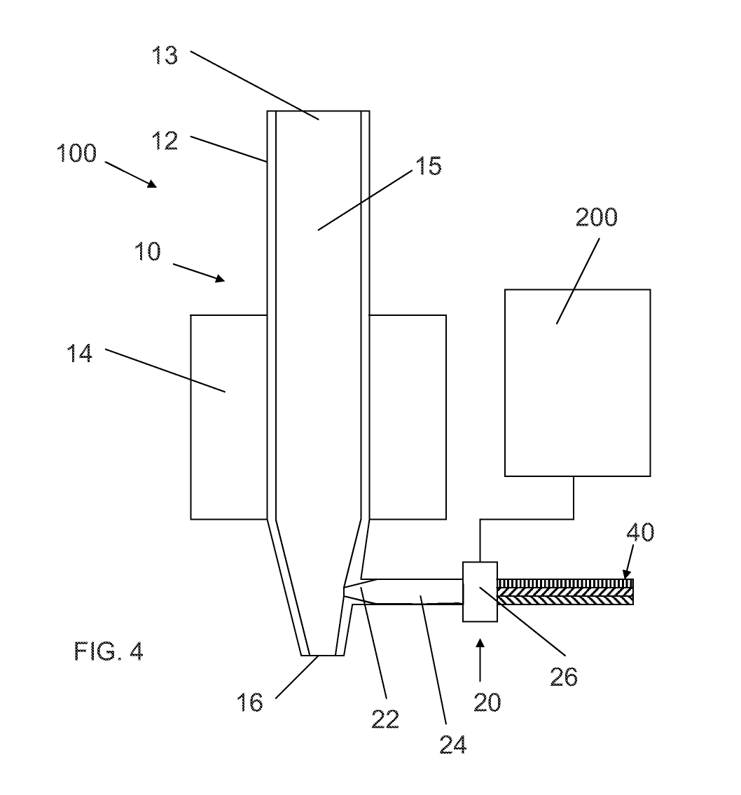

Referring to FIG. 1, a flowchart is presented in accordance with an example embodiment. The example method 101 is provided by way of example, as there are a variety of ways to carry out the method. The method 101 described below can be carried out using the configurations illustrated in FIGS. 4-11, for example, and various elements of these figures are referenced in explaining example method 101. Each block shown in FIG. 1 represents one or more processes, methods or subroutines, carried out in the example method 101. Furthermore, the illustrated order of blocks is illustrative only and the order of the blocks can change according to the present disclosure. Additional blocks can be added or fewer blocks can be utilized, without departing from this disclosure. The example method 101 can begin at block 102.

FIG. 1 is a flowchart of a first exemplary method 101 of extruding a multi-colored molten filament to form an object. The object is intended to be a copy of a base object. The base object can be an actual physical 3D multi-colored object which is “copied” in the manner of a 3D copying system by the exemplary extrusion methods described herein. Alternatively, the base object can comprise a virtual 3D multi-colored object in the form of data file representing the base object and then printed in the manner of a 3D printing system by the exemplary extrusion methods described herein.

The method can comprise feeding, through a feed tube of a nozzle assembly, a molten base filament for forming the size and shape of the object. (block 102). The molten base filament can comprise polyactic acid, also known as PLA. In at least one example, the raw molten base filament will not be colored (that is, colorless) or will be of a color (for example, a base color that can be easily colored) not representative of the final object to be created.

The method can comprise adding colorant, before the molten base filament leaves the nozzle assembly, to form a colored molten base filament. (block 104). The colorant can be a color representative of at least a portion of the object to be created.

The method 110 can comprise depositing the colored molten base filament to form the colored object.

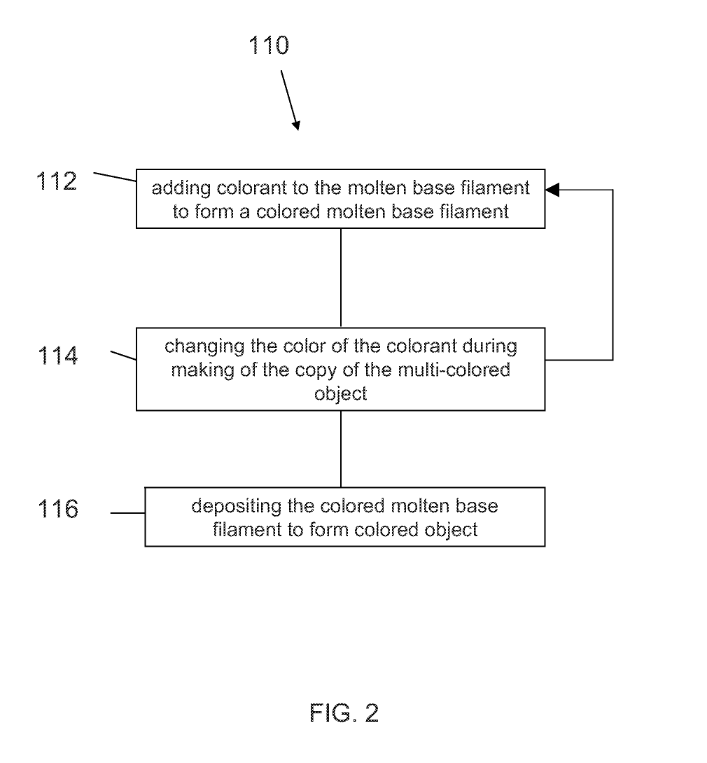

Referring to FIG. 2, a flowchart is presented in accordance with an example embodiment. The example method 110 is provided by way of example, as there are a variety of ways to carry out the method. The method 110 described below can be carried out using the configurations illustrated in FIGS. 4-11, for example, and various elements of these figures are referenced in explaining example method 110. Each block shown in FIG. 2 represents one or more processes, methods or subroutines, carried out in the example method 110. Furthermore, the illustrated order of blocks is illustrative only and the order of the blocks can change according to the present disclosure. Additional blocks can be added or fewer blocks can be utilized, without departing from this disclosure. The example method 110 can begin at block 112.

FIG. 2 is a flow chart further depicting the “adding colorant” as described above in relation to block 104 of FIG. 1.

As shown in FIG. 2, the exemplary method 110 can comprise adding colorant to the molten base filament to form a colored molten base filament. (block 112).

The method 110 can comprise changing the color of the colorant during making of the copy of the multi-colored object. (block 114).

Blocks 112 and 114 can be repeated in real time to change the color of the molten base filament as it is deposited to form the multi-colored colored object in block 116.

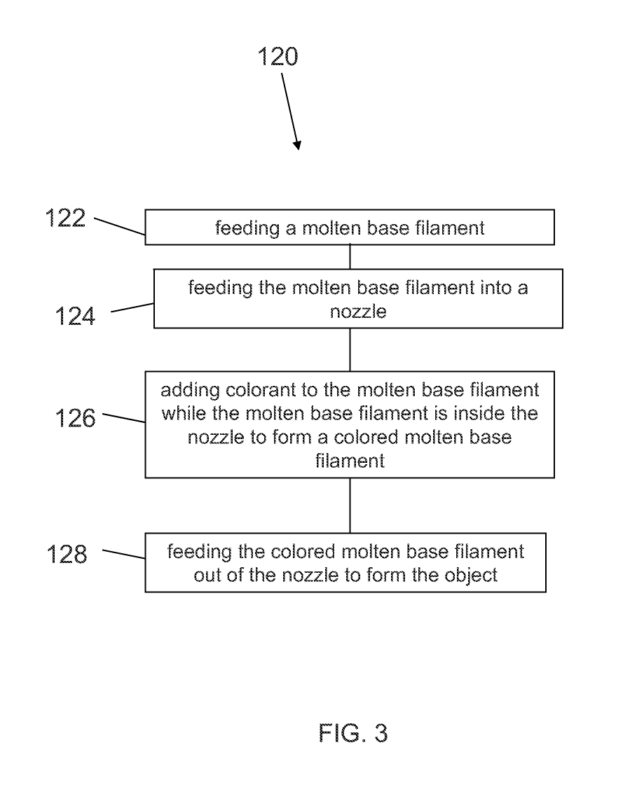

Referring to FIG. 3, a flowchart is presented in accordance with an example embodiment. The example method 120 is provided by way of example, as there are a variety of ways to carry out the method. The method 120 described below can be carried out using the configurations illustrated in FIGS. 4-11, for example, and various elements of these figures are referenced in explaining example method 120. Each block shown in FIG. 3 represents one or more processes, methods or subroutines, carried out in the example method 120. Furthermore, the illustrated order of blocks is illustrative only and the order of the blocks can change according to the present disclosure. Additional blocks can be added or fewer blocks can be utilized, without departing from this disclosure. The example method 120 can begin at block 122.

FIG. 3 is a flowchart of a second exemplary method of extruding a multi-colored molten filament to form an object.

The exemplary method can comprise feeding a molten base filament (block 122).

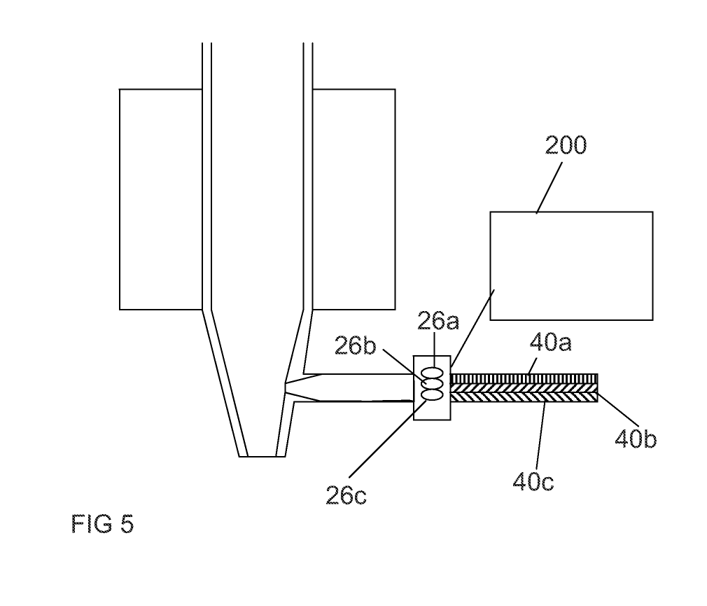

The exemplary method can also comprise feeding the molten base filament into a nozzle (block 124). Exemplary embodiments of a nozzle for use with the exemplary methods are described with reference to FIG. 4 and FIG. 5 herein.

The exemplary method can also comprise adding colorant to the molten base filament while the molten base filament is inside the nozzle to form a colored molten base filament (block 126).

Furthermore, the exemplary method can also comprise feeding the colored molten base filament out of the nozzle to form the object (block 128). Feeding can also be referred to as “extruding” by those skilled in the art.

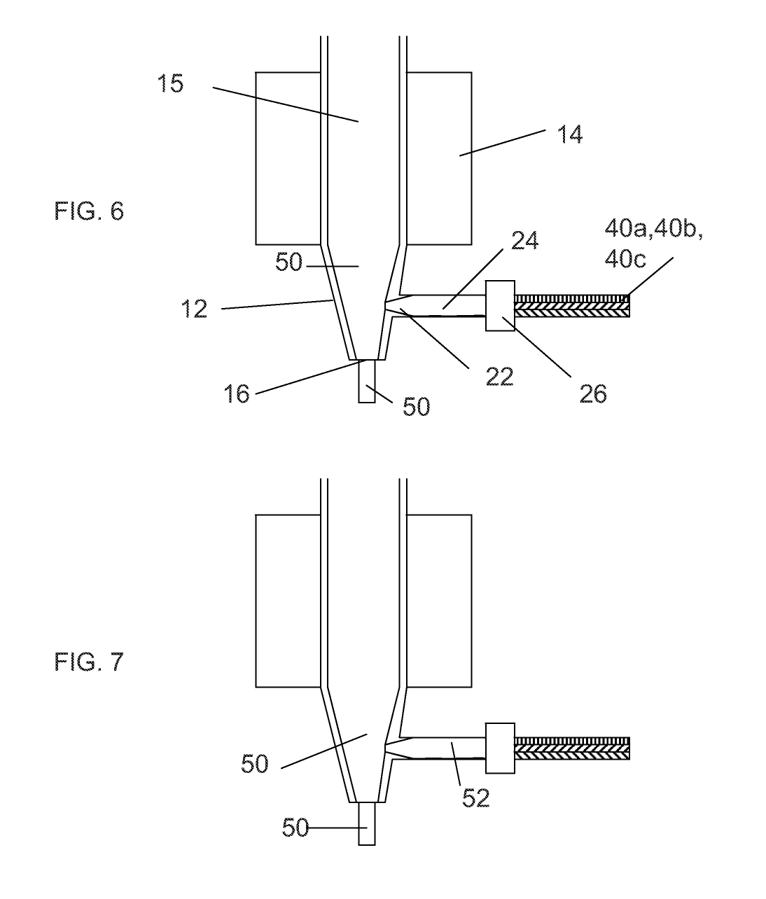

In the exemplary embodiments of FIG. 1 and FIG. 2, the color of the colored molten base filament can be changed in real time. The can be achieved using the method as depicted in FIG. 2 and as shown diagrammatically in FIG. 6-FIG. 11.

FIG. 4 is a diagrammatic illustration of a nozzle assembly 100 according to an exemplary embodiment and for use with any of the methods 101, 110, 120 described herein. Nozzle 100 can also be referred to as an “extrusion nozzle” or “3D print head”, depending on the usage of nozzle.

Extrusion nozzle assembly 100 comprises a filament feed assembly 10 and a colorant feed assembly 20. A source of pressurized molten base filament can be used to provide the molten base filament at desired pressure, so that a desired feed rate can be achieved.

The filament feed assembly 10 comprises a filament feed tube 12 having an inlet 13, an interior chamber 15, and an outlet 16. Filament feed assembly 10 also includes a heating element 14 surrounding portions of the filament feed tube 12 for maintaining the molten base filament flowing through the filament feed tube 12 in molten form.

The colorant feed assembly 20 comprises a colorant injector 22 in fluid communication with the interior chamber 15 of the filament feed tube 12, a mixing chamber 24, the mixing chamber 24 in fluid communication with the colorant injector 22, and at least one colorant pump 26 in fluid communication with the mixing chamber 24 for pumping colorant 40 into the mixing chamber 24, through the colorant injector 22, and then into the interior chamber 15 of the filament feed tube 12 to color molten base filament that is fed inside the nozzle interior chamber 15. Colored molten base filament is then fed through outlet 16 of filament feed tube 12 to form the object.

The nozzle assembly 100 further comprises a conventional controller 200, such as a CPU/microprocessor-based unit. Controller 200 is electronically coupled to the at least one colorant pump 26. Accordingly, the controller 200 can control the color of the colorant pumped into the mixing chamber by the at least one colorant pump 26 in real time.

As shown in FIG. 5, the colorant comprises a plurality of different colored color supplies 40a, 40b, and 40c. Furthermore, the at least one colorant pump 26 comprises a pump for each individual color supply. Thus, first pump 26a is associated with first color supply 40a, second pump 26b is associated with second color supply 40b, and third pump 26c is associated with third color supply 40c. The controller 200 and the pumps 26a, 26b, 26c control the amount of each color of color supplies 40a, 40b, 40c pumped into the mixing chamber 24. Thus, the final color of the molten base filament fed through the filament feed tube 12 can be changed in real time.

The colorant (color supplies) can come in a variety of forms. Most typically, the colorant can be a liquid ink or a liquid dye. The colorants can also be in RGB, CMYK or any other color spaces.

FIG. 6-FIG. 11 diagrammatically depict the exemplary extrusion of different colored molten base filaments using an exemplary embodiment of nozzle assembly 100. Reference numerals other than those related to colored and molten base filament have been omitted from all FIGS. except FIG. 6 for clarity. Reference numbers explicitly used in describing a particular feature are repeated.

In FIG. 6, molten base filament 50 is fed through interior chamber 15 and out of feed tube 12 via outlet 16. Pump(s) 26 are not pumping any colorants into mixing chamber 24. Molten base material 50 can be considered “uncolored”, “raw” or having any color other than a color associated with the final object's colors.

In FIG. 7, colorants 40a, 40b, 40c are injected into the mixing chamber 24 by pump(s) 26. Accordingly, a colorant mixture of a first color 52 is formed within mixing chamber 24. Molten base filament 50 (uncolored) continues to be fed out of filament feed tube 12.

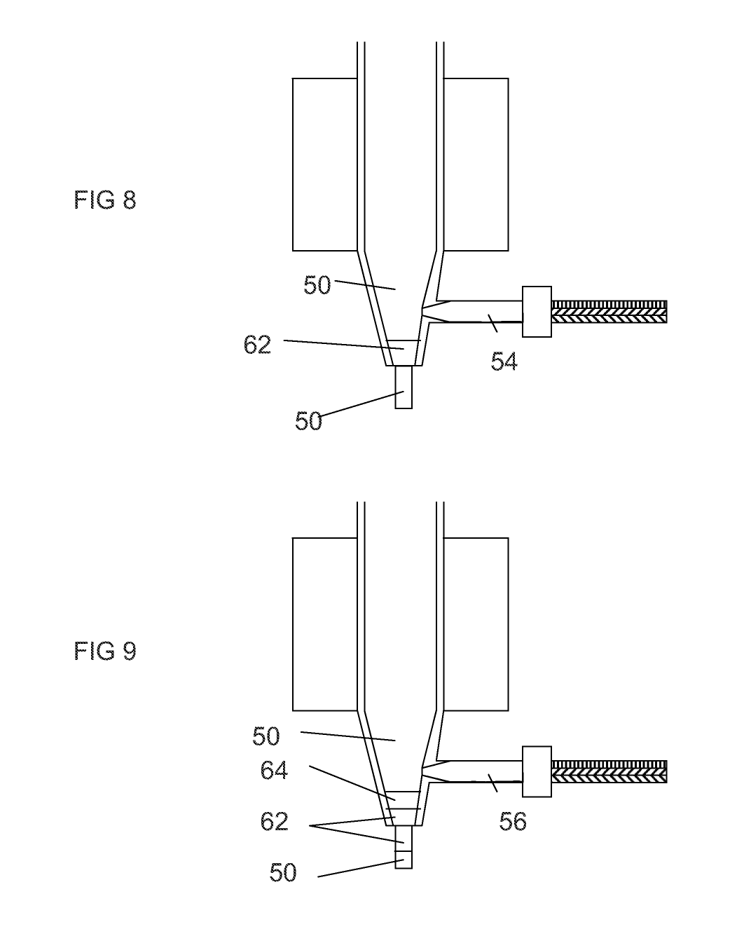

In FIG. 8, a different combination of colorants 40a, 40b, 40c is injected into the mixing chamber 24 by pump(s) 26. Accordingly, a colorant mixture of a second color 54 is formed within mixing chamber 24. The injection of color 54 into mixing chamber 24 causes color 52 to be injected through colorant injector 22 and into interior chamber 15 where it locally mixes with molten base filament 50 to form a colored slug 62 of colored molten filament in color 52. The heat created by the heater 14 keeps the molten base material molten so the mixing of the molten base filament 50 with the incoming colorant is generally uniform.

In FIG. 9, another different combination of colorants 40a, 40b, 40c is injected into the mixing chamber 24 by pump(s) 26. Accordingly, a colorant mixture of a third color 56 is formed within mixing chamber 24. The injection of color 56 into mixing chamber 24 causes color 54 to be injected through colorant injector 22 and into interior chamber 15 where it locally mixes with molten base filament 50 to form another colored slug 64 of colored molten filament; this time in color 54. The continuous feed of molten base filament 50 into, through, and then out of filament feed tube 12 cause all of colored slug 62 to be fed out of filament feed tube 12 and then colored slug 64 to be started to be fed out of filament feed tube 12.

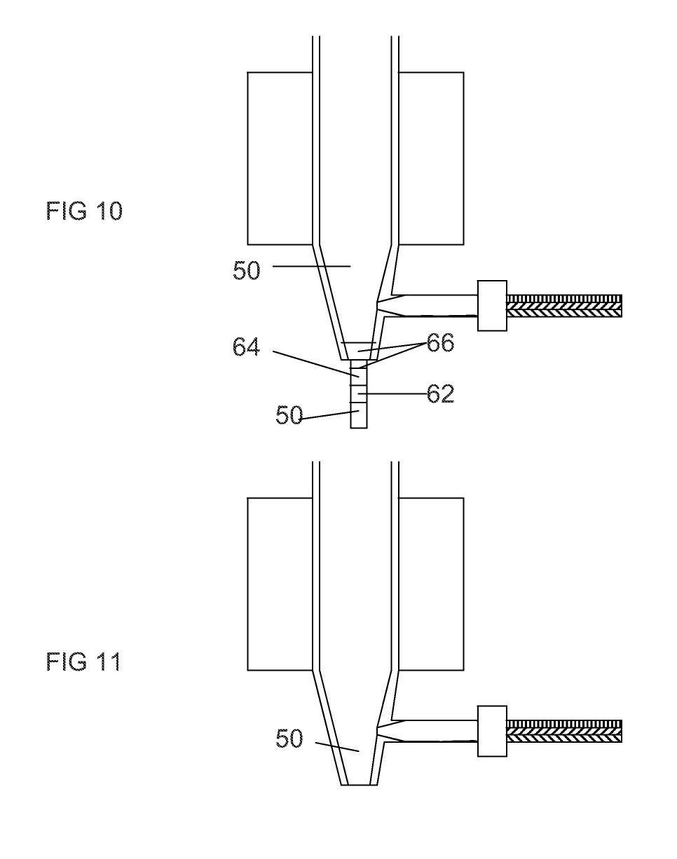

In FIG. 10, no colorants 40a, 40b, 40c are injected into the mixing chamber 24 by pump(s) 26. Accordingly, no colorant is within mixing chamber 24. Pumps 26 inject color C through colorant injector 22 and into interior chamber 15 where it locally mixes with molten base filament 50 to form another colored slug 66; this time of color 56. The continuous feed of molten base filament 50 into, through, and then out of filament feed tube 12 cause molten base filament 50 to form behind the colored slugs 62, 64, 66. This process of changing the color of the molten base filament 50 into colored slugs continues continuously and in real time until the final multi-colored object is formed.

After the final multi-colored object is formed, as shown in FIG. 11, there are no longer any colored slugs inside the nozzle and the flow of molten base filament F out of the nozzle is stopped.

In an exemplary method and nozzle, the diameter of the molten base filament going into filament inlet 12 can be approximately 1.75 mm. The diameter of the colored molten base filament flowing through outlet 16 can be between 0.25 mm and 0.8 mm depending on the application.

The colored portions of the molten base filament (e.g., 52, 54, 56, etc.), referred to herein as “slugs”, are very small relative to the incoming molten base filament. In an exemplary embodiment, the smallest slug (quantized) can be approximately 0.25 mm dia.×0.25 mm length; thereby having a slug volume of approximately 0.0122 mm̂3. Of the slug volume, it is approximated that adding about 3% of the slug volume as colorant will locally color the molten base filament to the desired color. Of course, as one skilled in the art would recognize, the amount of colorant needed will vary dependent on the carrier selected. For example, when using more volatile carriers, less colorant is needed.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. A method of forming a colored object, the method comprising:
feeding, through a feed tube of a nozzle assembly, a molten base filament for forming the shape of the object; and
adding colorant, before the molten base filament leaves the nozzle assembly, to the molten base filament to form a colored molten base filament;
extruding the colored molten base filament to form the colored object.

2. The method of claim 1, further comprising:
further comprising changing a color of the colorant in real-time during extrusion, thereby creating a multi-colored object.

3. The method of claim 2, further comprising:
adding a mixture of different colorants to the molten base filament; and
wherein changing the color of the colorant in real-time during making of the object further comprises changing the combination of the different colorants that mix with the molten base filament and therefore change the color of the molten base filament for depositing in real-time.

4. The method of claim 1, further comprising:
feeding the molten base filament into, through, and out of, a nozzle; and
adding the colorant to the molten base filament while the molten base filament is inside the nozzle.

5. The method of claim 1, further comprising the forming the object further comprises forming a multi-colored three-dimensional object.

6. The method of claim 1, further comprising forming a shape of the colored object comprises copying the size and shape of a physical object.

7. The method of claim 1, further comprising forming a shape of the colored object comprises copying the size and shape of a virtual object.

8. The method of claim 1, wherein the adding colorant to the molten base filament further comprises:
changing a color of the colorant mixed with the molten base filament inside the nozzle and in real time to form differently colored molten base filament slugs that color the molten base filament.

9. A method of forming a multi-colored object comprising:
feeding a molten base filament into a nozzle assembly;
mixing colorant having a first color with the molten base filament, inside the nozzle assembly;
forming a first colored molten base filament slug, comprising the molten base filament and colorant, inside the nozzle assembly; and
feeding the first colored molten base filament slug out of the nozzle assembly.

10. The method of claim 9, further comprising:
feeding additional molten base filament into the nozzle assembly;
mixing a colorant of a second color with the additional molten base filament inside the nozzle assembly to form a second colored molten base filament slug, comprising the molten base filament and colorant, inside the nozzle assembly; and
feeding the second colored molten base filament slug out of the nozzle assembly.

11. The method of claim 9, further comprising:
feeding additional molten base filament into the nozzle assembly;
changing, the color of the colorant mixed with the molten base filament inside the nozzle assembly in real time to form differently colored molten base filament slugs inside the nozzle assembly; and
feeding the differently colored molten base filament slugs out of the nozzle assembly.

12. The method of claim 11, wherein feeding the differently colored molten base filament slugs out of the nozzle assembly is carried out to form a multi-colored 3D object.

13. The method of claim 11, wherein the feeding of the molten base filament and forming the colored molten base filament slugs are continuous processes.

14. A nozzle assembly comprising:
a filament feed assembly, the filament feed assembly comprising: a filament feed tube having an inlet, an interior chamber, and an outlet;
a colorant feed assembly, the colorant feed assembly, comprising:
a colorant injection section coupled to the interior chamber of the filament feed tube;
a mixing chamber having an inlet and an outlet, the outlet of the mixing chamber coupled to the colorant injection section; and
at least one colorant pump coupled to the mixing chamber for pumping colorant into the mixing chamber, through the colorant injection section, and then into the interior chamber of the filament feed tube to color molten base filament that is fed into the filament feed tube.

15. The nozzle assembly of claim 14, further comprising:
a controller coupled to the at least one colorant pump, the controller configured to control a color of the colorant pumped into the mixing chamber in real time.

16. The nozzle assembly of claim 15, wherein:
the colorant comprises a plurality of different colored color supplies;
the colorant pump comprises a pump for each individual color supply; and
by the controller and the pump controlling the amount of each color supply pumped into the mixing chamber, wherein a final color of the molten base filament fed through the filament feed tube can be changed in real time.

17. The nozzle assembly of claim 16. wherein the colorant is an liquid ink.

18. The nozzle assembly of claim 16, wherein the colorant is a liquid dye.

19. The nozzle assembly of claim 14, further comprising a heating element at least partially surrounds the filament feed tube for maintaining the filament flowing through the filament feed tube in molten form.
